(19) United States
(12) Patent Application Publication
(10) Pub. No.: US 2014/0118995 A1
(43) Pub. Date: May 1, 2014

(54) FLOOR LAMP WITH DRAWER

(71) Applicant: Ching-Hui CHEN, Huizhou City (CN)

(72) Inventor: Ching-Hui CHEN, Huizhou City (CN)

(21) Appl. No.: 13/963,313

(22) Filed: Aug. 9, 2013

(30) Foreign Application Priority Data
Nov. 1, 2012 (CN) 201220572913.7

(51) Int. Cl. F21V 33/00

(52) U.S. Cl. CPC F21V 33/0012
USPC 362/127

(57) ABSTRACT

The invention discloses a floor lamp with a drawer, which comprises a frame body, wherein a lampshade is disposed on the upper portion of the frame body, and a partition is arranged inside the frame body which is provided with at least one drawer. Compared with the prior art, as the floor lamp with the drawer, provided by the invention, is provided with the drawer capable of holding articles, the articles can be conveniently stored and taken out, so that the lamp has multiple functions. Moreover, the floor lamp with the drawer, provided by the invention has the advantages of simple structure and convenient assembly and installation.

### FIELD OF THE INVENTION

The invention relates to a floor lamp with a drawer, which belongs to the technical field of lighting fixtures.

### BACKGROUND OF THE INVENTION

In the prior art, a floor lamp comprises uprights, partitions and a lampshade, wherein the partitions are arranged inside a frame body which is composed of a plurality of uprights; the lampshade is disposed on the top of the frame body; and the number of the partitions may be one or more and may be set according to the design requirement. However, the floor lamp has a single function and cannot be used for holding other articles.

### SUMMARY OF THE INVENTION

The technical problem to be solved by the invention is to provide a floor lamp with a drawer, providing convenience for the storage of articles.

The invention may adopt the technical proposal that:

The invention provides a floor lamp with a drawer, which comprises a frame body, wherein a lampshade is disposed on the upper portion of the frame body, and a partition is arranged inside the frame body which is provided with at least one drawer.

In order to solve the problem, the following further improvements may also be adopted:

The frame body has at least two uprights; each upright is composed of at least two struts; various struts of the same upright are on the same straight line; and the partition is disposed between two adjacent struts which are connected with each other.

The drawer is arranged under the partition.

The number of the uprights is four.

The drawer is connected with the frame body through a slide construction.

Two supports constitute the slide construction; each support is provided with a chute; the two supports are respectively disposed on both sides of the drawer; two side plates of the drawer are provided with a slider respectively; and the sliders are extended into the chutes of respective corresponding supports fixed on the frame body.

The opening direction of the chutes for the supports is upward, and the sliders are arranged on upper edges of the two side plates of the drawer.

The supports are disposed between the partition and corresponding struts.

By adoption of the technical proposal, the floor lamp with the drawer, provided by the invention, has the advantages that:

1. Compared with the prior art, as the floor lamp with the drawer, provided by the invention, is provided with the drawer capable of holding articles, the articles can be conveniently stored and taken out, so that the lamp has multiple functions.

2. The floor lamp with the drawer, provided by the invention, has a simple structure and is convenient in assembly and installation.

### BRIEF DESCRIPTION OF THE DRAWINGS

FIG. 1 is a schematic diagram of an embodiment of a floor lamp with a drawer, provided by the invention;

FIG. 2 is an enlarged view of the construction of the portion of the drawer;

FIG. 3 is a structure diagram of the drawer; and

FIG. 4 is a schematic diagram of supports.

### DETAILED DESCRIPTION OF THE PREFERRED EMBODIMENTS

Detailed description is given below to the invention with the preferred embodiments.

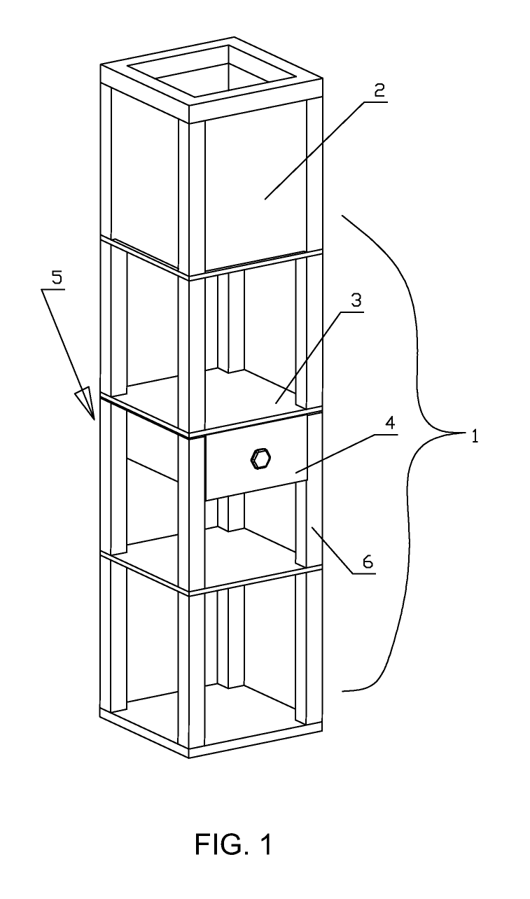

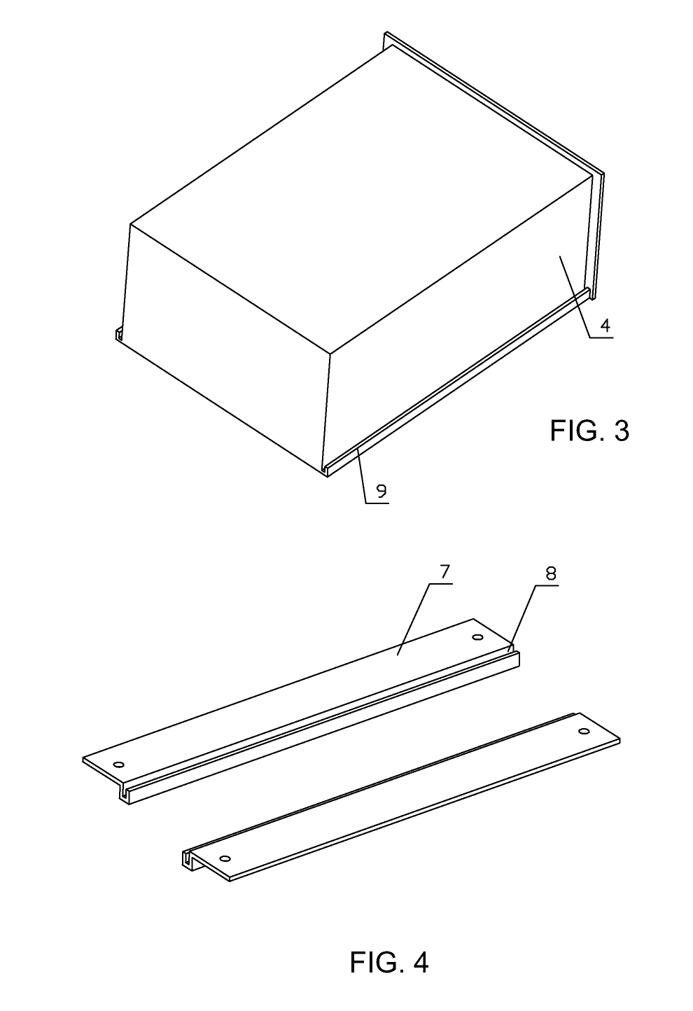

Embodiment: as illustrated in FIGS. 1 to 4, a floor lamp with a drawer comprises a frame body 1, wherein a lampshade 2 is disposed on the upper portion of the frame body 1, and a partition 3 is arranged inside the frame body 1 which is provided with a drawer 4.

The frame body 1 is composed of at least three uprights 5. In the embodiment, the number of the uprights 5 is four. Each upright 5 is composed of at least two struts 6; various struts 6 of the same upright 5 are on the same straight line; and the partition 3 is disposed between two adjacent struts 6. Moreover, the two adjacent struts 6 are connected with each other, that is, the two adjacent struts 6 are connected with each other by means of bolts passing through the partition.

The drawer 4 is arranged under the partition 3 and connected with the frame body 1 through a slide construction.

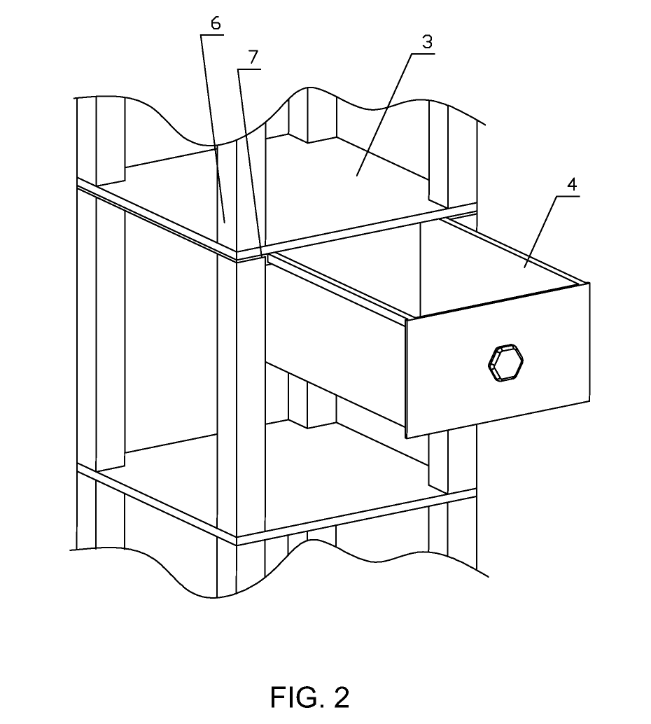

As illustrated in FIGS. 2 to 4, two supports 7 constitute the slide construction; each support 7 is provided with a chute 8; the two supports 7 are respectively disposed on both sides of the drawer 4; two side plates of the drawer 4 are provided with a slider 9 respectively; and the sliders 9 are extended into the chutes 8 of respective corresponding supports 7 fixed on the frame body 1. Moreover, the supports are disposed between the partition and corresponding struts. When the two adjacent struts of the same upright are connected, corresponding supports may be connected as well. By adoption of the structure, the floor lamp with the drawer, provided by the invention, is convenient in installation and assembly.

The opening direction of the chutes 8 of the supports 7 is upward, and the sliders 9 are arranged on upper edges of the two side plates of the drawer 4.

Of course, the drawer may be connected with the frame body through other general slide constructions. The number of the drawer(s) may be set according to the design requirement and may be multiple.

The foregoing is only the preferred embodiments of the invention and not intended to limit the invention. Any modification, equivalent replacement, improvement and the like made without departing from the spirit and principle of the invention shall all fall within the scope of protection of the invention.

What is claimed is:

1. A floor lamp with a drawer, comprising a frame body, wherein a lampshade disposed on the upper portion of the frame body, and a partition arranged inside the frame body provided with at least one drawer.

2. The floor lamp with the drawer according to claim 1, wherein the drawer is arranged under the partition.

3. The floor lamp with the drawer according to claim 1, wherein the frame body has at least two uprights; each upright is composed of at least two struts; various struts of the same upright are on the same straight line; and each partition is disposed between two adjacent struts which are connected with each other.

4. The floor lamp with the drawer according to claim 3, wherein the drawer is arranged under the partition.

5. The floor lamp with the drawer according to claim 3, wherein the number of the uprights is four.

6. The floor lamp with the drawer according to claim 1, wherein the drawer is connected with the frame body through a slide construction.

7. The floor lamp with the drawer according to claim 6, wherein two supports constitute the slide construction; each support is provided with a chute; the two supports are respectively disposed on both sides of the drawer; two side plates of the drawer are provided with a slider respectively; and the sliders are extended into the chutes of respective corresponding supports fixed on the frame body.

8. The floor lamp with the drawer according to claim 7, wherein the opening direction of the chutes for the supports is upward, and the sliders are arranged on upper edges of the two side plates of the drawer.

9. The floor lamp with the drawer according to claim 7, wherein the supports are disposed between the partition and corresponding struts.
